(19) United States
(12) Patent Application Publication
(10) Pub. No.: US 2012/0091215 A1
(43) Pub. Date: Apr. 19, 2012

(54) COATED CONCRETE RAILROAD-TIES AND METHODS FOR MAKING SAME

(75) Inventor: Rick Malone, Denver, CO (US)

(73) Assignee: EFI Polymers, Denver, CO (US)

(21) Appl. No.: 12/903,675

(22) Filed: Oct. 13, 2010

(51) Int. Cl. E01B 3/32; C08F 2/46

(52) U.S. Cl. 238/84; 427/487

(57) ABSTRACT

A concrete railroad-tie having a radiation-cured coating covering at least 5% of the exterior surface and a having a median thickness between 0.005 inches and 0.125 inches. The coating comprises the reaction product of radiation curable oligomers selected from the group consisting of epoxy acrylates, urethane acrylates, polyester acrylates, and combinations thereof. Method of providing the same.

### FIELD

One or more embodiments of the present application relate to concrete railroad-ties that are completely or partially coated with one or more radiation cured coatings, as specified herein.

### SUMMARY

The present application describes concrete railroad-ties, where at least 5% of the exterior surface is coated with a radiation-cured coating. The coating generally has a median thickness between 0.005″ and 0.125″ and comprises the reaction product of radiation curable oligomers selected from the group consisting of epoxy acrylates, urethane acrylates, polyester acrylates, and combinations thereof. In one or more embodiments, the coating is the reaction product of radiation curable oligomers, diluting monomer, and photoinitiators.

In one or more embodiments, the present application further describes a method for providing a coated concrete railroad-tie by providing a radiation curable coating mixture comprising at least one oligomer selected from the group consisting of epoxy acrylates, urethane acrylates, polyester acrylates, and combinations thereof, and a photoinitiator, and applying the mixture to the exterior of the railroad-tie. Electromagnetic radiation is thereafter applied to the mixture such that the coating is sufficiently cured. In one or more embodiments, the mixture contains diluting monomer. In still other embodiments, the mixture contains amine synergist and at least one stabilizer.

Other aspects of this disclosure will be apparent to the ordinarily skilled artisan from the description of various embodiments that follows. In that description, the following definitions apply throughout unless the surrounding text explicitly indicates a contrary intention:

“Actinic radiation”, “electromagnetic radiation”, and “radiation” are used interchangeably herein, and mean electromagnetic radiation that can produce photochemical reactions, and includes but is not limited to visible light and ultraviolet radiation;

“Oligomer” and “resin” are used interchangeably herein, and mean a relatively low molecular weight polymer in which the number of repeating units ranges from about two to about one hundred.

### DETAILED DESCRIPTION

Generally, according to one or more embodiments described in the present application, a concrete railroad-tie having a radiation-cured exterior coating is described, along with one or more methods of providing such railroad-ties. The improved railroad-ties described herein show good weatherability and performance characteristics (e.g., toughness, flexibility, abrasion resistance, chemical resistance, and adhesion). Advantageously, the radiation-cured coatings described herein are capable of being applied to concrete railroad-ties using a variety of coating methods, and may be cured in a variety of settings, including outdoor environments having relatively low temperatures, as compared with thermally-cured coatings, allowing for greater manufacturing flexibility.

According to one or more embodiments of the present application, a concrete railroad-tie is provided where a radiation-cured coating covers a portion of the exterior surface of the railroad-tie. The radiation-cured coating comprises the reaction product of radiation curable oligomers selected from the group consisting of epoxy acrylates, urethane acrylates, polyester acrylates, and combinations thereof. In one or more embodiments, the radiation-cured coating comprises the reaction product of the aforementioned oligomers and diluting monomer or photoinitiators, or both.

In general, the coatings described herein have improved weatherability and performance as their median thickness increases. However, the cost of such coatings increases as thickness increases, and performance may begin to decrease at relatively large thicknesses. Accordingly, in certain embodiments, the radiation-cured coatings described herein have a median thickness between 0.005 and 0.125 inches. In one or more preferred embodiments, the coatings have a median thickness between 0.010 and 0.100 inches; in others, between 0.020 and 0.050 inches.

The railroad-ties of the present application are generally any size and shape known in the art. In certain embodiments, the ties are configured to have a rectangular shape and a relatively uniform exterior surface. In other embodiments, at the two locations where the track is to be seated (“track seat areas”), the exterior surface is not flush (i.e., either raised above or seated below) with the remaining exterior surface area. In certain embodiments, the radiation-cured coating covers at least 5% of the exterior surface of the railroad-tie. In one or more embodiments, the coating covers at least 25% of the exterior surface; in others, at least 50% of the exterior surface. In other embodiments, the coating covers only the track seat areas.

In one or more embodiments, the radiation-cured coatings described herein are the reaction product of coating formulations comprising one or more radiation curable oligomers or resins capable of adhering to concrete ties and of providing good weatherability and performance. Generally, such oligomers or resins are selected from the group consisting of epoxy acrylates, urethane acrylates, polyester acrylates, and combinations thereof.

Epoxy acrylates are oligomers that are known in the art and may generally be described as the reaction product of an epoxide compound and hydroxy alkyl acrylate compounds (including but not limited to acrylic acid), resulting in an oligomer having one or more terminal acrylate moieties. In one or more embodiments described herein, the epoxy acrylate is a modified, unmodified, aliphatic, or aromatic epoxy acrylate. By way of non-limiting example, suitable epoxy acrylates are commercially available from Cytec Industries as Ebecryl® 600, 605, 608, 645, 860, 1608, 3200, 3201, 3212, 3300, 3411, 3415, 3500, 3600, 3605, 3700, 3701, 3701-201, 3702, 3703, 3708, 3720, 3720-HD20, 3720-TM20, 3720-TM40, 3720-TP25, 3720-TP40, 3730-TP20, 3740, and 3740-TP20; and from RAHN USA as GENOMER® 2235, 2253, 2255, 2259, 2263, and 2280. In one embodiment, the epoxy acrylate is bisphenol-A epoxy diacrylate having the formula:

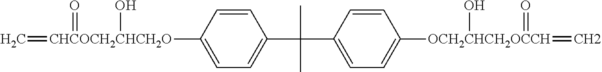

Urethane acrylates are oligomers that are known in the art and may generally be described as the reaction product of an isocyanate compound (an oligomer or polymer bearing one or more isocyanate functional groups) with one or more hydroxy alkyl acrylates (including but not limited to acrylic acid), resulting in an oligomer having one or more urethane linkages and one or more terminal acrylate moieties. In one or more embodiments described herein, the urethane acrylate is a modified, unmodified, aliphatic, or aromatic urethane acrylate. By way of non-limiting example, suitable urethane acrylates are commercially available from Cytec Industries as Ebecryl® 220, 230, 244, 264, 265, 270, 284, 280/15IB, 1290, 4827, 4830 , 4833, 4849, 4866, 4883, 8210, 8301-R, 8311, 8402, 8405, 8411, 8701, 8800, 8800-20R, 8804, 8807 and 8808; and from RAHN USA as GENOMER® 4188/EHA, 4215, 4217, 4269/M22, 4302, 4312, 4316, 4425, 4590/PP, 4622, and 00-022. Urethane acrylates generally exhibit a high level of performance, such as good yellowing-resistance and weatherability; however, commercially available . urethane acrylates are generally the most expensive of the oligomors discussed herein.

Polyester acrylates are oligomers that are known in the art and may generally be described as the reaction product of a polyester compound having one or more hydroxyl groups (such as, by way of non-limiting example, a dibasic acid/aliphatic diol-based polyester) and one or more hydroxy alkyl acrylates (including but not limited to acrylic acid), resulting in an oligomer having one or more terminal acrylate moieties. In one or more embodiments described herein, the polyester acrylate is a modified or unmodified polyester acrylate. Preferably, the polyester acrylate is an amine-modified polyester acrylate. Suitable polyester acrylates include but are not limited to those commercially available from Cytec Industries as Ebecryl® 80, 81, 83, 436, 438, 450, 524, 586, 657, 809, 810, 811, 812, 838, 870, 871, 885, 887, 888, 889, 891, 1657, and 2870. Polyester acrylates typically exhibit better performance than epoxy acrylates and poorer performance than urethane acrylates.

One or more types of oligomer may be used in the coating formulations described herein, depending on factors such as cost and performance requirements. The total amount of oligomer utilized in the coating formulations is generally between 15% and 98%, by total weight of the coating formulation. In one or more preferred embodiments, the amount of oligomer is preferably between 25% and 80%; more preferably between 30% and 70%.

In one or more embodiments described herein, the coating formulation contains a photoinitiator. In general, a photoinitiator is a compound that initiates a chemical reaction by absorbing a photon to form an initiating species—i.e, a free radical, an acid, or a base. Use of photoinitiators allows actinic radiation to cause polymerization of the coating formulation to occur at a practicable cure rate. Suitable photoinitiators are known in the art, and preferably one or more free radical-forming photoinitiators are used herein. Non-limiting examples of photo-initiators are aromatic ketone compounds, phosphine oxide compounds, phenylglyoxylate compounds, and organic peroxide compounds. Suitable photoinitiators include but are not limited to those commercially available from Sartomer, Sigma-Aldrich, and Cytec Industries. In one or more preferred embodiments, the photoinitiator is commercially available from Cytec Industries as Additol® BCPK, CPK, LX and TPO.

The photoinitiator content in the coating formulation is preferably from 0.05 to 10% by weight, based on the total amount of oligomer. In one or more embodiments, the photoinitiator content is from 0.1 to 8% by weight; preferably from 0.1 to 2% by weight. The amount of energy required for curing the coating formulations described herein varies depending on the photoinitiator type and content, but is generally preferably from 10 to 5,000 ml/cm², more preferably from 50 to 3,000 mJ/cm², and still more preferably from 200 to 2,000 ml/cm².

In general, curing the coating formulations described herein using actinic radiation may be accomplished using any suitable manner known in the art. Non-limiting examples of suitable radiation sources are electrodeless bulbs, such as those commercially available from Fusion UV Systems Inc. In one or more embodiments, the coating formulations described herein include photoinitiators that are optimally sensitive to ultraviolet radiation, and the radiation source therefore most advantageously has a spectrum in the range from 200 to 500 nm; more preferably from 200 to 450 nm; and still more preferably from 250 to 400 nm. Fusion bulbs having output maxima at 340 to 390 nm (“D” bulbs) are particularly useful.

During the curing of the coated concrete ties described herein, the ties may be at rest or may be urged past the radiation source (e.g., bulb) at an appropriate speed. The amount of energy received by the coating formulation depends on, among other factors, the rate of movement of the concrete tie past the radiation source (or vice-versa) and the output of the radiation source. The amount of energy required for curing the coating formulations described herein varies depending on the photoinitiator type and content, but is generally preferably from 10 to 5,000 mJ/cm², more preferably from 50 to 3,000 mJ/cm², and still more preferably from 200 to 2,000 mJ/cm².

In general, one or more diluting agents may be added to the coating formulation to adjust the viscosity. Suitable diluting agents include low viscosity, ethylenically unsaturated monomers that are capable of additive polymerization, and are generally known in the art (“diluting monomer”). Non-limiting examples of suitable diluting monomers include acrylates; acrylamide; methacrylamide; vinyl aromatics; and allyl compounds. Preferably, suitable diluting monomers include Tripropylene glycol diacrylate (available commercially as Cytec TRPGDA), 1,6-Hexanediol diacrylate (available commercially as Cytec HDODA), and Ethoxylated (3) trimethylolpropane triacrylate (available commercially as Sartomer SR454).

The amount of diluting monomer present in the coating formulations described herein is generally dependent on the desired viscosity of the coating formulation. Generally, the diluting monomer is present in an amount between 0% and 60%, by total weight of the coating formulation. Preferably, the diluting monomer is present in an amount between 10% and 50%; still more preferably between 15% and 40%.

The coating formulations described herein may optionally include additives known in the art, in customary amounts. Non-limiting examples include: photoactivators (such as commercially available Cytec Ebecryl® P115) antioxidants/stabilizers, defoamers (such as silicone defoamers), catalysts, lubricants, thixotroping agents (such as fumed silica commercially available as Degussa® Aerosil 200), adhesion promoters, photosensitizers, curing accelerators, dyes, pigments, devolatizers, and leveling agents.

Suitable viscosity at 25° C. of the coating formulations described herein depends on a number of factors, including the type of coating method used to apply the coating formulation to the concrete ties and the environment (e.g., temperature) in which it is to be applied. Typically, suitable viscosity is between 100 cps and 50,000 cps; preferably between 100 cps and 10,000 cps; still more preferably between 100 cps to 2,500 cps.

The coating formulation may be applied to the concrete ties in generally any manner capable of providing a coating of uniform thickness and coverage. Non-limiting examples include using a painter's brush, paint roller, trowel, sprayer, or roll-coater to apply a layer of coating formulation to the exterior of the concrete ties. Generally, the thickness of the radiation-cured coating depends on the coating method used, the viscosity of the formulation, and the manner in which it is applied. The thickness generally increases as the viscosity of the coating formulation increases and/or the shear stresses associated with the coating method decrease. In one or more embodiments described herein, the coating formulation, after cure, has a median thickness between 0.005 and 0.125 inches. In one or more preferred embodiments, the coatings have a median thickness between 0.010 and 0.100 inches; in others, between 0.020 and 0.050 inches.

The embodiments disclosed herein will be more readily understood by reference to the following examples. There are, of course, many other embodiments or illustrations which will become apparent to one skilled in the art, and it will accordingly be recognized that these examples are given for the purpose of illustration only, and are not to be construed as limiting the scope of the claims in any way.

### Example 1

Raw materials are added to a mixing vessel in the amounts listed in Table 1 and mixed with good vortex until well blended.

TABLE 1

| Material | Type | % |
|---|---|---|
| Cytec Ebercyl 885 | polyester acrylate | 66 |
| Cytec Ebercyl 891 | modified polyester acrylate | 20 |
| Cytec Ebecryl HDODA | 1,6-Hexanediol diacrylate | 10 |
| Cytec Ebecryl P115 | copolymerizable amine | 3 |
| Cytec Additol BCPK | benzophenone/1-hydroxy- | 1 |
| | cyclohexylphenyl-ketone | |
| | photoinitiator mixture | |

The coating formulation is applied to a rectangular concrete railroad-tie over 10-15% of the exterior surface, using either a painter's brush, paint roller, trowel, or sprayer. The concrete tie is moved past a Fusion F300 UV system (“D” bulb, 1.3 J/cm2, UVA_{320-390 nm}) at 15 feet per minute. The resulting coating is solid, flexible, and tack-free.

### Example 2

Raw materials are added to a mixing vessel in the amounts listed in Table 2 and mixed with good vortex until well blended.

TABLE 2

| Material | Type | % |
|---|---|---|
| Cytec Ebecryl 3708 | modified epoxy diacrylate | 67.0 |
| Sartomer SR454 | ethoxylated trimethylolpropane triacrylate | 28.5 |
| Cytec Ebecryl P115 | copolymerizable amine | 4.0 |
| Cytec Additol BCPK | benzophenone/1-hydroxy- | 0.5 |
| | cyclohexylphenyl-ketone | |
| | photoinitiator mixture | |

The coating formulation is applied to a rectangular concrete railroad-tie over 10-15% of the exterior surface, using either a painter's brush, paint roller, trowel, or sprayer. The concrete tie is moved past a Fusion F300 UV system (“D” bulb, 1.3 J/cm2, UVA_{320-390 nm}) at 15 feet per minute. The resulting coating is solid, flexible, and tack-free.

### Example 3

Raw materials are added to a mixing vessel in the amounts listed in Table 3 and mixed with good vortex until well blended.

TABLE 3

| Material | Type | % |
|---|---|---|
| Cytec Ebecryl 3720-TP40 | bisphenol-A epoxy diacrylate | 47.9 |
| Cytec Ebecryl 3708 | modified epoxy diacrylate | 24.0 |
| Cytec Ebecryl HDODA | 1,6-Hexanediol diacrylate | 19.2 |
| Cytec Ebecryl P115 | copolymerizable amine | 3.8 |
| Cytec Additol BCPK | benzophenone/1-hydroxy- | 0.9 |
| | cyclohexylphenyl-ketone | |
| | photoinitiator mixture | |
| Cytec Additol LX | photoinitiator blend | 0.2 |
| Byk-088 | silicone defoamer | 0.2 |
| Degussa Aerosil 200 | fumed silica | 3.8 |

The coating formulation is applied to a rectangular concrete railroad-tie over 10-15% of the exterior surface, using either a painter's brush, paint roller, trowel, or sprayer. The concrete tie is moved past a Fusion F300 UV system (“D” bulb, 1.3 J/cm2, UVA_{320-390 nm}) at 15 feet per minute. The resulting coating is solid, flexible, and tack-free.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

We claim:

1. A coated railroad-tie comprising:
(a) a concrete railroad-tie having an exterior surface, and
(b) a radiation-cured coating covering at least 5% of the exterior surface, where the radiation-cured coating has a median thickness between 0.005 inches and 0.125 inches and comprises the reaction product of radiation curable oligomers selected from the group consisting of epoxy acrylates, urethane acrylates, polyester acrylates, and combinations thereof.

2. The coated railroad-tie of claim 1, where the radiation-cured coating comprises the reaction product of: (i) radiation curable oligomer selected from the group consisting of epoxy acrylates, urethane acrylates, polyester acrylates, and combinations thereof, and (ii) diluting monomer.

3. The coated railroad-tie of claim 2, where the radiation-cured coating comprises the reaction product of: (i) radiation curable oligomer selected from the group consisting of epoxy acrylates, urethane acrylates, polyester acrylates, and combinations thereof, (ii) diluting monomer, and (iii) photoinitiator.

4. The railroad-tie of claim 3, where the radiation curable oligomer is an epoxy acrylate selected from the group consisting of modified, unmodified, aliphatic, and aromatic epoxy acrylates, and combinations thereof.

5. The railroad-tie of claim 3, where the radiation curable oligomer is a modified bisphenol-A epoxy diacrylate.

6. The railroad-tie of claim 3, where the radiation curable oligomer is a urethane acrylate selected from the group consisting of modified, unmodified, aliphatic, and aromatic urethane acrylates, and combinations thereof.

7. The railroad-tie of claim 3, where the radiation curable oligomer is an aliphatic urethane diacrylate.

8. The railroad-tie of claim 3, where the radiation curable oligomer is a polyester acrylate selected from the group consisting of modified and unmodified polyester acrylates, and combinations thereof.

9. The railroad-tie of claim 3, where the radiation curable oligomer is an amine-modified polyester tetra-acrylate.

10. A method for providing a coated railroad-tie comprising the steps of:
(a) providing a concrete railroad-tie,
(b) providing a radiation curable coating mixture comprising (i) at least one oligomer selected from the group consisting of epoxy acrylates, urethane acrylates, polyester acrylates, and combinations thereof, and (ii) photoinitiator,
(c) applying the radiation curable coating mixture to the exterior of the railroad-tie; and
(d) applying electromagnetic radiation to the radiation curable coating mixture applied to the exterior of the railroad-tie such that the coating is sufficiently cured.

11. The method of claim 10, where the radiation curable coating mixture further comprises diluting monomer.

12. The method of claim 11, where the radiation curable coating mixture further comprises at least one amine synergist and at least one stabilizer.

13. The method of claim 11, where the oligomer is an epoxy acrylate selected from the group consisting of modified, unmodified, aliphatic, and aromatic epoxy acrylates, and combinations thereof.

14. The method of claim 11, where the oligomer is a modified bisphenol-A epoxy diacrylate.

15. The method of claim 11, where the oligomer is a urethane acrylate selected from the group consisting of modified, unmodified, aliphatic, and aromatic urethane acrylates, and combinations thereof.

16. The method of claim 11, where the oligomer is an aliphatic urethane diacrylate.

17. The method of claim 11, where the oligomer is a polyester acrylate selected from the group consisting of modified and unmodified polyester acrylates, and combinations thereof.

18. The method of claim 11, where the oligomer is an amine-modified polyester tetra-acrylate.

19. The method of claim 11, where the diluting monomer is added to the radiation curable coating mixture in an amount sufficient to provide a viscosity between 100 cps and 50,000 cps.

20. The method of claim 11, where the radiation curable coating mixture is applied to the exterior of the concrete railroad-tie by using a painter's brush, paint roller, trowel, sprayer, or roll-coater in such a manner that, after the radiation curable coating mixture is cured, it has a median thickness between 0.005″ and 0.125″.
